(19) United States
(12) Patent Application Publication
(10) Pub. No.: US 2016/0291174 A1
(43) Pub. Date: Oct. 6, 2016

(54) CHARGED PARTICLE DETECTING DEVICE AND GAMMA CAMERA

(71) Applicant: CANON KABUSHIKI KAISHA, Tokyo (JP)

(72) Inventor: Kazuyoshi Ishii, Tokyo (JP)

(21) Appl. No.: 15/037,965

(22) PCT Filed: Jan. 27, 2015
(86) PCT No.: PCT/JP2015/052789

§ 371 Date: May 19, 2016

(30) Foreign Application Priority Data
Feb. 4, 2014 (JP) 2014-019810

(51) Int. Cl. G01T 1/29

(52) U.S. Cl. CPC G01T 1/2935

(57) ABSTRACT

A charged particle detecting device according to the present invention includes an electron detecting portion, a signal processing portion, a selection portion, an accumulation portion configured to accumulate information on a muon, and a computation portion. The electron detecting portion detects an ionized electron generated along a trajectory of a charged particle flying within a scatterer. The signal processing portion processes a signal detected by the electron detecting portion, to thereby acquire information on the charged particle. The selection portion selects information on a muon from the information on the charged particle detected by the signal processing portion. The computation portion acquires a coefficient for sensitivity in detection of the information on the charged particle based on the accumulated information on the muon.

### TECHNICAL FIELD

The present invention relates to a charged particle detecting device, and a gamma camera configured to perform environmental radiation measurement, nuclear medical diagnosis, or the like by using the charged particle detecting device.

### BACKGROUND ART

Hitherto, there is known a Compton camera, which is a type of gamma camera configured to measure the intensity distribution of a gamma ray generated from a radiation source and display the intensity distribution as an image. The Compton camera uses Compton scattering caused between an incident gamma ray and a scatterer so as to detect an incident direction of the incident gamma ray. In this case, calculation of the incident direction of the incident gamma ray requires not only energy of a scattered gamma ray caused by the Compton scattering and a scattering direction vector but also energy of a recoil electron caused by the Compton scattering and a recoil direction vector. For detection of the recoil electron, a charged particle detecting device capable of detecting not only energy but also a position of a trajectory is used.

In PTL 1, as an example, there is disclosed a charged particle detecting device including a gas serving as a scatterer, a field application unit configured to drift an ionized electron, and a microstrip gas chamber (MSGC) serving as an electron detecting unit formed of electrodes arranged in two dimensions. In this detecting device, the recoil electron caused by the Compton scattering between the incident gamma ray and electrons within gas molecules continuously flies while ionizing the gas molecules, to thereby generate an electron cloud formed of a large number of ionized electrons on the trajectory of the recoil electron. The electron cloud drifts to the MSGC due to a force applied from an electric field formed by the field application unit, while maintaining the same shape as that of the trajectory of the recoil electron. The MSGC amplifies the electron, and detects a position (X and Y coordinates) of the electron cloud (trajectory) projected onto a two-dimensional plane. On the other hand, a distance (Z coordinate) between the MSGC and the trajectory is detected based on a drift velocity of the ionized electron and a difference between a time point at which the scattered gamma ray is detected by a gamma ray detector, that is, a time point at which the Compton scattering occurs, and a time point at which the ionized electron is detected in the MSGC. In this case, a velocity of the scattered gamma ray is extremely high, and hence the time point at which the Compton scattering occurs can be assumed the same as the time point at which the scattered gamma ray is detected. In this manner, a three-dimensional position of the trajectory of the recoil electron can be calculated.

### CITATION LIST

### Patent Literature

PTL 1: Japanese Patent Application Laid-Open No. 2001-13251

### SUMMARY OF INVENTION

### Technical Problem

According to PTL 1, the energy of the recoil electrons is obtained based on a length of the trajectory and energy of the ionized electron detected in the MSGC. However, in actuality, due to a component vaporized from a member that forms the device or other such factors, the component of a gas serving as the scatterer changes with a lapse of time, followed by a change in electron amplification factor in the electron detecting unit. Further, normally, hydrocarbon is mixed into the gas serving as the scatterer in order to suppress discharge, but with a lapse of time, a polymerization product of the hydrocarbon may adhere to a surface of the MSGC to cause a change in the electron amplification factor. As a result, a quantitative relation (sensitivity) of a detection value of the ionized electron with respect to the actual energy of the recoil electron fluctuates. Therefore, there is a problem in that an error gradually increases with a lapse of time when the energy of the recoil electron is calculated based on the detection value of the electron by using a fixed coefficient (numerical value for sensitivity) set in advance.

In order to prevent such a problem from occurring, it is necessary to frequently perform a calibration to update the coefficient used for calculating the energy of the recoil electron. This necessitates calibration work or the like performed by a worker while measuring a gamma ray, which leads to complicated work such as repetition of installation and retreat of some standard radiation sources different in energy.

### Solution to Problem

In view of the above-mentioned problem, a charged particle detecting device according to one embodiment of the present invention includes: an electron detecting portion configured to detect an ionized electron generated along a trajectory of a charged particle flying within a scatterer; a signal processing portion configured to process a signal detected by the electron detecting portion, to thereby acquire information on the charged particle (such as energy Ke of recoil electron, recoil direction vector e of electron, and three-dimensional position data); a selection portion configured to select information on a muon from the information on the charged particle acquired by the signal processing portion; an accumulation portion configured to accumulate the information on the muon; and a computation portion configured to acquire a coefficient for sensitivity in detection of the information on the charged particle based on the accumulated information on the muon.

Further features of the present invention will become apparent from the following description of exemplary embodiments with reference to the attached drawings.

### BRIEF DESCRIPTION OF DRAWINGS

FIG. 1 is a diagram illustrating a schematic configuration of a gamma camera according to the present invention.

FIG. 2 is a diagram illustrating configurations of an electron detecting circuit and a gamma ray detecting circuit according to Embodiment 1.

FIG. 3 is a diagram illustrating configurations of an electron detecting circuit and a gamma ray detecting circuit according to Embodiment 2.

FIG. 4 is a diagram illustrating how a muon flies within a chamber.

FIG. 5 is a diagram illustrating how a gamma ray and a recoil electron fly within the chamber.

FIG. 6 is a graph showing a distribution of energy Kμ of the muon near a ground surface.

FIG. 7 is a graph showing a relationship between the energy Kμ of the muon and an energy loss dKμ/dx.

FIG. 8 is a graph showing a distribution of the value of a coefficient Aμ calculated in a calibration.

### DESCRIPTION OF EMBODIMENTS

Preferred embodiments of the present invention will now be described in detail in accordance with the accompanying drawings.

In the present invention, an ionized electron generated along a trajectory of a charged particle flying within a scatterer is detected, and a detected signal thereof is processed to acquire information on the charged particle. Then, information on a muon is selected from the acquired information on the charged particle and accumulated, and a coefficient for sensitivity in detection of the information on the charged particle is acquired based on the accumulated information on the muon. A unit configured to detect the ionized electron may be any unit as long as the unit can detect a signal from which the information on the charged particle can be acquired by processing.

Typically, of the information on the charged particle acquired through detection of the ionized electron, the energy of the charged particle is calculated by using the coefficient. Further, the information on the muon is selected based on positional information on the trajectory of the charged particle. Further, the coefficient is determined based on an energy loss of the muon and the positional information on the trajectory in addition to the accumulated information on the muon. Further, in a first operation mode for measuring the charged particle other than the muon, it is also possible to measure a photoelectron or the like generated by an interaction called photoelectric absorption other than Compton scattering.

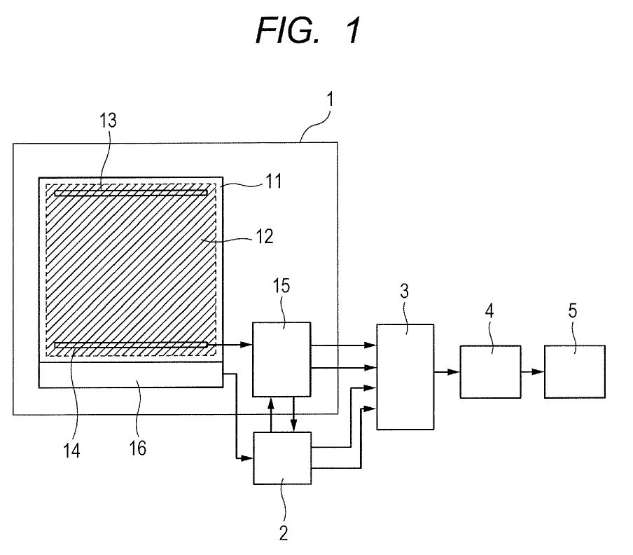

A charged particle detecting device and a gamma camera according to an embodiment of the present invention are described. First, an entire schematic configuration of the gamma camera and an operation thereof are described with reference to FIG. 1. A charged particle detecting device 1 includes a chamber 11 serving as a sealed container for a gas 12 serving as a scatterer, an electrode 13 and an electron detector 14 serving as an electron detecting portion that are installed within the chamber 11, a gamma ray detector 16, and an electron detecting circuit 15 serving as a signal processing portion. A recoil electron and a scattered gamma ray are generated as a result of the Compton scattering between an individual incident gamma ray (photon) that has arrived from a radiation source and entered the chamber 11 and an electron within a molecule of the gas 12. The recoil electron (electron cloud formed thereof) is detected by the electron detector 14, and the scattered gamma ray is detected by the gamma ray detector 16.

The electron detecting circuit 15 calculates the energy of the recoil electron, a position of a Compton scattering point, and a recoil direction vector based on the detection data on the recoil electron. Further, a gamma ray detecting circuit 2 calculates the energy of the scattered gamma ray and a scattering direction vector based on the detection data on the scattered gamma ray. A gamma ray incident direction computing circuit 3 calculates an arrival direction of the incident gamma ray based on the energy of the recoil electron, the recoil direction vector, the energy of the scattered gamma ray, and the scattering direction vector for each individual Compton scattering phenomenon. An image reconstruction device 4 converts an intensity distribution into image data based on an incident direction of the incident gamma ray for a plurality of Compton scattering phenomena, and displays the intensity distribution on a display device 5 with a tone or a color difference.

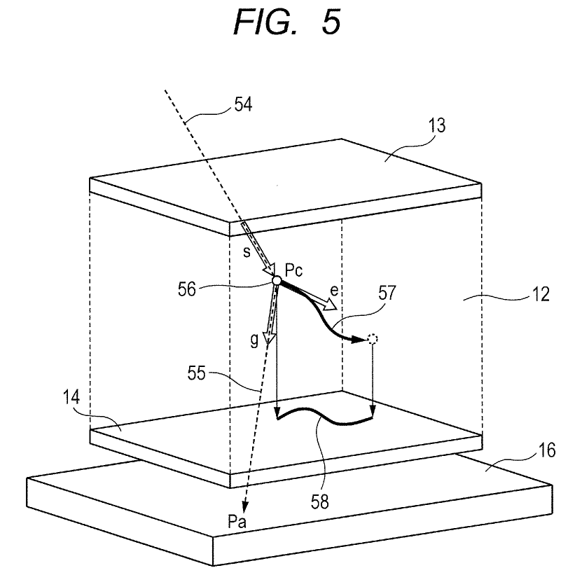

Next, with reference to FIG. 5, the charged particle detecting device 1 is described in detail. An incident gamma ray 54 (photon) having the energy of approximately 100 keV to 2,000 keV that has entered the chamber 11 causes the Compton scattering with the electron within the molecule of the gas 12 (for example, argon or xenon). As a result, a scattered gamma ray 55 and a recoil electron 56 that have energy smaller than the incident gamma ray 54 are generated. When the energy of the incident gamma ray 54 is represented by E0, the energy of the recoil electron 56 is represented by Ke, and the energy of the scattered gamma ray 55 is represented by Eγ, a relationship of E0=Ke+Eγ is established. The recoil electron 56 receives scattering sequentially due to the molecules of the gas 12 while flying within the chamber 11, and generates the ionized electron at each time of the scattering. In this case, Pc represents the Compton scattering point, and Pa represents an absorption point of the scattered gamma ray 55 obtained by the gamma ray detector 16. Further, s represents an incident direction vector (unit vector in the incident direction) of the incident gamma ray 54, g represents a scattering direction vector (unit vector in the scattering direction) of the scattered gamma ray 55, and e represents a recoil direction vector (unit vector in the recoil direction at the Compton scattering point Pc) of the recoil electron 56.

An electron cloud 57 formed of a large number of ionized electrons is generated on a line segment along the trajectory of the recoil electron 56. The recoil electron 56 gradually loses energy at each time of ionization, and finally loses all the energy to stop. The interval and direction of the scattering of the recoil electron 56 are irregular, and hence the trajectory, that is, the shape of the electron cloud 57 also has a linear shape that is irregularly curved as illustrated.

The electron detector 14 is a two-dimensional detector such as an MSGC having a flat shape, and is mounted to a lower part within the chamber 11 as illustrated in FIG. 1. The electron detector 14 is formed of a plurality of detectors corresponding to pixels or lines, and also has a function of amplifying an electron. The electrode 13 has a flat shape, and is mounted to an upper part within the chamber 11 so as to face the electron detector 14 in parallel. Through application of a predetermined voltage between the electrode 13 and the electron detector 14 by a voltage applicating portion, an electric field perpendicular to the electron detector 14 is formed in a region occupied by the gas 12 sandwiched between the electrode 13 and the electron detector 14. As a result of the Compton scattering, as illustrated in FIG. 5, the electron cloud 57 generated within the region drifts due to a force applied from the electric field while maintaining its shape, and a position (X and Y coordinates) of a projection 58 of the electron cloud 57 onto the electron detector 14 is detected. On the other hand, the scattered gamma ray 55 is detected by the gamma ray detector 16 placed below the chamber 11.

### Embodiment 1

The charged particle detecting device 1 according to this embodiment has two operation modes of a gamma ray measuring mode (first mode) and a calibration mode (second mode) that are executed separately from each other.

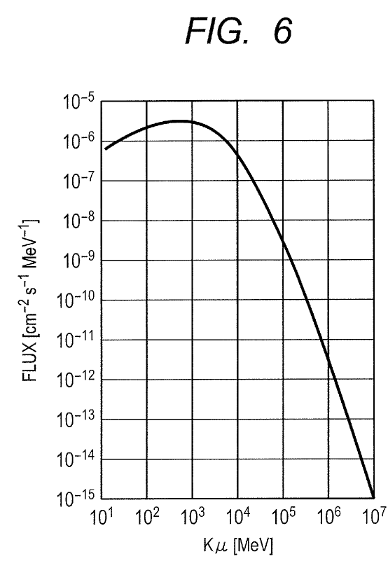

First, the calibration mode is described. In this mode, the muon serving as a secondary cosmic ray existing in the natural world is used to obtain a coefficient used for calculating the energy of the recoil electron based on the detection data of the recoil electron. The muon represents a high-energy charged particle having a charge, and in the same manner as the recoil electron, has an ionizing ability with respect to the molecule of the gas 12. FIG. 6 shows a distribution of energy Kμ of the muon observed near a ground surface. The energy Kμ has a peak at 100 MeV to 2,000 MeV. For example, assuming that the dimensions of a top surface of the chamber 11 are 100 mm×100 mm, the number of only the muons entering the chamber from the top surface within the above-mentioned energy range is approximately 2,000 per hour. The muon having such high energy has extremely high permeation capability, and therefore enters even a concrete building with little attenuation. Accordingly, there is no limitation on a use place of the charged particle detecting device 1 according to the present invention.

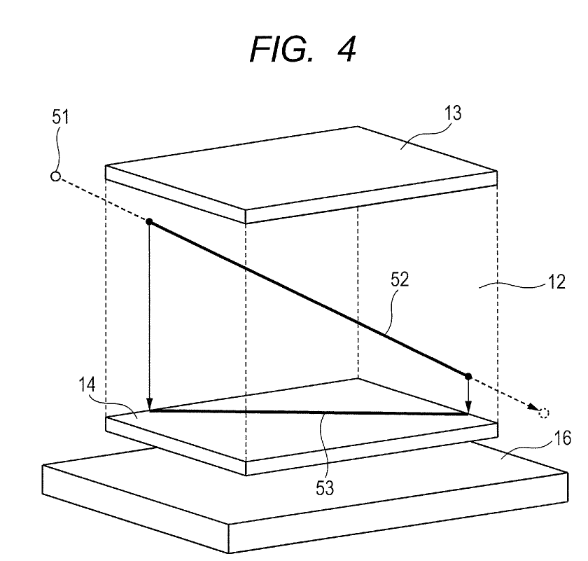

The muon flies while generating the ionized electron within the chamber 11 in the same manner as the recoil electron generated by the Compton scattering. This state is illustrated in FIG. 4. An electron cloud 52 formed of a large number of ionized electrons is generated on a line segment along the trajectory of a muon 51 entering the chamber 11. An energy loss of the muon 51 due to the ionization is extremely smaller than the original energy, and hence the muon 51 penetrates the chamber 11 without stopping halfway. Further, a mass of the muon is approximately 200 times as large as that of an electron, and hence a scattering angle is extremely small even when an interaction occurs with the electron, with the result that the trajectory has a shape of a substantially straight line. As described above, the electron cloud 52 drifts due to the force applied from the electric field while maintaining its shape, and a position (X and Y coordinates) of a projection 53 onto the electron detector 14 is detected.

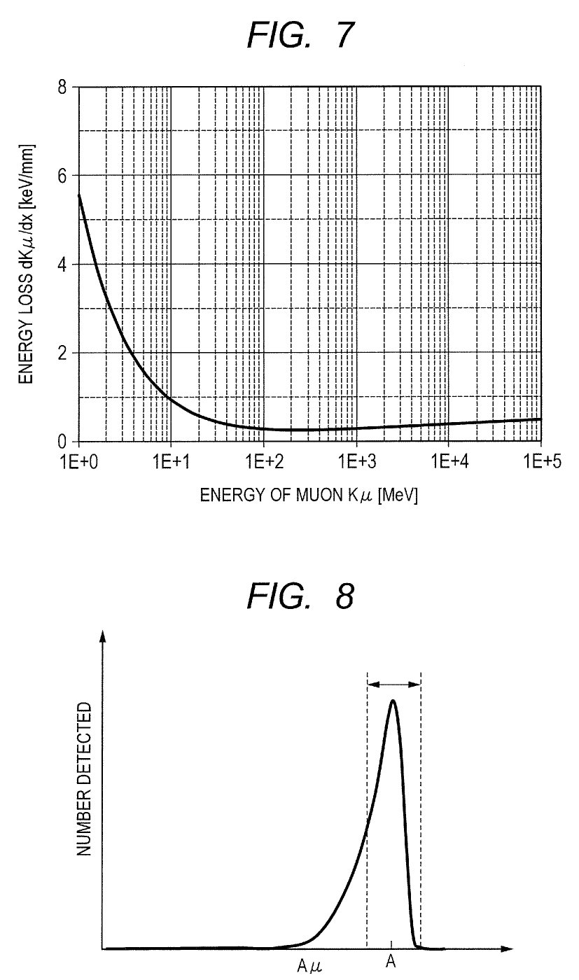

FIG. 7 shows a relationship between the energy Kμ of the muon 51 and an energy loss dKμ/dx per flying distance 1 mm within an argon gas at 1 atm. When the energy Kμ is 100 MeV to 2,000 MeV, the energy loss dKμ/dx becomes minimum, and a value thereof becomes substantially constant at 0.25 keV/mm. In this manner, also because the ratio of the energy loss to the original energy is extremely small, the trajectory of the muon 51 has the straight line shape while being hardly affected by the scattering unlike the above-mentioned case of the recoil electron 56 illustrated in FIG. 5.

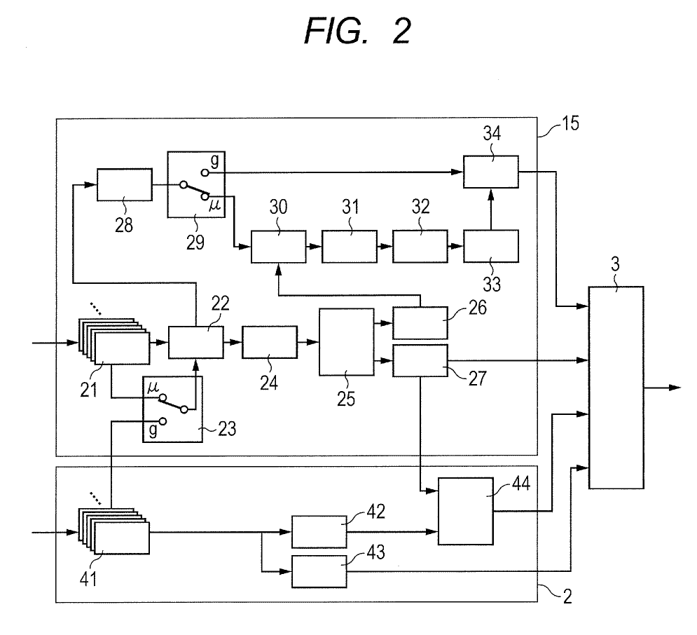

FIG. 2 illustrates configurations of the electron detecting circuit 15 and the gamma ray detecting circuit 2 according to this embodiment. When the calibration mode (second mode) is designated by a controller (not shown), a switch 23 and a switch 29 of the electron detecting circuit 15 are changed to a side indicated by “μ” in FIG. 2. Within the chamber 11, the electron cloud due to the Compton scattering is also generated when a gamma ray arriving from any radiation source enters the chamber 11 together with the electron cloud generated by the incident muon. The electron cloud ascribable to a factor other than the muon is unnecessary for the calibration, and hence it is desired to minimize the entry of the gamma ray by a shielding unit or a method of keeping the chamber 11 away from an unnecessary radiation source.

The electron cloud generated from the Compton scattering of one muon or gamma ray (photon) drifts and sequentially arrives at the electron detector 14 to be amplified. The respective parts of one electron cloud are detected by a plurality of detectors that form a pixel or a line of the electron detector 14, and electric signals corresponding to the charges (number of electrons) are generated. The electric signals obtained from those detectors continue after a leading edge of the electron cloud arrives until a trailing edge arrives. The electric signals obtained from the plurality of detectors are amplified by a plurality of corresponding amplification portions 21, and are output to the data acquisiting portion 22. Further, a trigger signal is generated from a rise of a signal corresponding to the leading edge of the electron cloud, and is output to the data acquisiting portion 22 via the switch 23. The data acquisiting portion 22 acquires all the electric signals corresponding to a predetermined time period with the trigger signal as a start point. Here, it is assumed that the predetermined time period is set equal to or larger than D/V when an interval between the electron detector 14 and the electrode 13 is D and a drift velocity of the electron cloud is V. With this configuration, all the electric signals obtained from the respective detectors corresponding to one electron cloud are acquired.

The acquired electric signals are output to a trajectory coordinate calculating portion 24 together with time information using the trigger signal as an initial point. Further, based on the electric signals, a total charge corresponding to one electron cloud is calculated by a total charge detecting portion 28. For each part of the electron cloud detected by the electron detector 14, the trajectory coordinate calculating portion 24 calculates the position (X,Y) within the detection surface of the electron detector 14 and a position (Z) in a direction perpendicular to the detection surface, which is determined based on a product of a drift time ΔT using the trigger signal as a reference and a drift velocity V. Then, based on the position (X,Y) and the position (Z), three-dimensional position data on each part of the electron cloud is generated.

Subsequently, the selection portion 25 selects data on the muon from the three-dimensional position data on the electron cloud. The data is selected by using the following difference between the shape of the electron cloud generated from the muon and the shape of the electron cloud generated from the Compton scattering of the gamma ray. As illustrated in FIG. 4, the electron cloud 52 generated from the muon 51 has the shape of a substantially straight line. Further, the muon 51 penetrates the chamber 11, and hence end points (start point and terminal point) of the electron cloud 52 are always within an inner wall of the chamber 11. On the other hand, as illustrated in FIG. 5, the electron cloud 57 generated from the Compton scattering of the gamma ray has a linear shape that is irregularly curved. Further, the start point (Compton scattering point) and the terminal point (stop location of the recoil electron) are indefinite positions within the chamber 11.

A muon information calculating portion 26 calculates an entire length L of the trajectory based on the three-dimensional position data on the electron cloud of each individual muon selected in this manner, and accumulates the entire length L in a memory portion 30 serving as an accumulation portion together with total charge data Qμ corresponding to the entire length L. In addition, a muon energy calculating portion 31 calculates a total energy loss Kμd of the muon within the chamber 11. Kμd=L×(dKμ/dx), where dKμ/dx represents an energy loss of the muon per unit length. As described above, assuming that the scatterer is the argon gas at 1 atm, the energy loss dKμ/dx becomes minimum when the energy Kμ is 100 MeV to 2,000 MeV, and a value thereof is substantially constant at 0.25 keV/mm. Here, the calculation is performed assuming that dKμ/dx is constant at the value of 0.25 keV/mm for all the detected muons.

Subsequently, a coefficient calculating portion 32 serving as a computation portion calculates a coefficient Aμ−Kμd/Qμ as a ratio of the total energy loss Kμd to the total charge Qμ detected for individual muons. The above-mentioned operation is performed for a predetermined time period or until the selected muons reach a predetermined number. FIG. 8 shows a distribution of the value of the coefficient Aμ calculated in this manner. In a majority of the incident muons, as shown in FIG. 6, the energy Kμ ranges from 100 MeV to 2,000 MeV, but in some of the incident muons, the energy Kμ falls out of this range. For such muons, the actual value of the energy loss dKμ/dx per unit length is larger than the local minimum value of 0.25 keV/mm as shown in FIG. 7. Accordingly, the coefficient Aμ calculated on the assumption that all the incident muons have the energy loss dKμ/dx of 0.25 keV/mm shows a distribution that the number of detected muons is large near the maximum value of Aμ and the number becomes smaller as the value decreases as shown in FIG. 8. Data within a predetermined range indicated by the arrow in FIG. 8 near the maximum value of Aμ in this distribution is data corresponding to the muon whose energy is substantially 100 MeV to 2,000 MeV. Therefore, an average value of the coefficient Aμ included in this range is determined, and is saved in the memory portion 33 as a coefficient A, which is a ratio (sensitivity) of the energy Ke of the charged particle (recoil electron) to the detected charge Qe. For example, a point of zero is selected as a larger side with respect to the peak value, and a point of a half of the peak value is selected as a smaller side, to thereby set the above-mentioned range between the two points. This range may also be determined based on the distribution graphs of FIG. 6 and FIG. 7. Further, the peak value of Aμ may also be used as it is. In this manner, the calibration is completed. The line on the right side of a peak A shown in FIG. 8 is supposed to be logically perpendicular, but in actuality, the measurement result always involves an error, thereby exhibiting a wider distribution.

Note that, the above-mentioned calibration may be performed for each region such as a pixel or a line of the electron detector 14, to thereby set coefficients A1 to An (n represents the number of regions) for each region. It is desired that the execution of the calibration be fully automated so that the calibration may be executed, for example, at midnight every day in a time slot when measurement of the gamma ray is not performed. Further, according to this embodiment, the ratio (sensitivity) of the energy Ke of the charged particle (recoil electron) to the detected charge Qe is saved in the memory portion 33 as the coefficient A, but another parameter for determining the sensitivity may be saved in the memory portion 33 as the coefficient.

Next, the gamma ray measuring mode (first mode) is described. In this mode, the recoil electron generated as a result of the Compton scattering of the incident gamma ray is detected by the electron detector 14, to thereby calculate the energy of the recoil electron, the position of the Compton scattering points, and the recoil direction vector. When the gamma ray measuring mode is designated by a controller (not shown), in FIG. 2, the switch 23 and the switch 29 of the electron detecting circuit 15 are changed to the side indicated by “g” in FIG. 2. The gamma ray arriving from the radiation source enters the chamber 11. Then, the scattered gamma ray and the recoil electron are generated by Compton scattering, and the electron cloud is generated due to an ionization effect of the recoil electron. As described above, the electron cloud drifts and sequentially arrives at the electron detector 14 to be amplified. The respective parts of one electron cloud are detected by a plurality of detectors that form a pixel or a line of the electron detector 14, and electric signals corresponding to the charges (number of electrons) are generated. The electric signals obtained from those detectors continue after the leading edge of the electron cloud arrives until the trailing edge arrives. The electric signals obtained from the plurality of detectors are amplified by the plurality of corresponding amplification portions 21, and are output to the data acquisiting portion 22.

On the other hand, the scattered gamma ray is detected by the gamma ray detector 16, and an output signal thereof is amplified by an amplifier 41 of the gamma ray detecting circuit 2. The amplifier 41 outputs a signal corresponding to the detection of the gamma ray to the data acquisiting portion 22 via the switch 23 as a trigger signal. The data acquisiting portion 22 acquires all the electric signals corresponding to a predetermined time period with the trigger signal set as the start point. Here, as described above, it is assumed that the predetermined time period is set equal to or larger than D/V when the interval between the electron detector 14 and the electrode 13 is D and the drift velocity of the electron cloud is V. With this configuration, all the electric signals obtained from the respective detectors corresponding to one electron cloud are acquired. The acquired electric signals are output to the trajectory coordinate calculating portion 24 together with the time information using the above-mentioned trigger signal as an initial point. Further, based on the electric signals, the total charge corresponding to one electron cloud is calculated by the total charge detecting portion 28.

For each part of the electron cloud detected by the electron detector 14, the trajectory coordinate calculating portion 24 calculates the position (X,Y) within the detection surface of the electron detector 14 and the position (Z) in a direction perpendicular to the detection surface, which is determined based on a product of the drift time ΔT using the trigger signal as a reference and the drift velocity V. Then, based on the position (X,Y) and the position (Z), the three-dimensional position data on each part of the electron cloud is generated.

Next, the selection portion 25 selects the electron cloud generated from the Compton scattering of the gamma ray from the three-dimensional position data on the electron cloud. The electron cloud generated from the Compton scattering of the gamma ray has a linear shape that is irregularly curved as illustrated in FIG. 5. Further, the start point (Compton scattering point) and the terminal point (stop location of the recoil electron) are indefinite positions within the chamber 11. Such a characteristic of the shape of the electron cloud can be used to perform the selection.

In addition, a recoil electron information calculating portion 27 calculates the Compton scattering point Pc and the recoil direction vector e (unit vector in the recoil direction at the Compton scattering point Pc) based on the three-dimensional position data on each individual extracted electron cloud. Then, the data is transmitted to the gamma ray incident direction computing circuit 3. Further, an electron energy calculating portion 34 reads the coefficient A calculated through the above-mentioned calibration from the memory portion 33, to thereby calculate the energy Ke=A·Qe of each individual recoil electron based on the total charge Qe calculated by the total charge detecting portion 28. When the calibration is performed for each region such as a pixel or a line of the electron detector 14, the coefficients A1 to An set for each region are used to perform the calculation. Data on the energy Ke of each individual recoil electron thus obtained is transmitted to the gamma ray incident direction computing circuit 3.

On the other hand, the detection signal of each individual scattered gamma ray, which is amplified by the amplifier 41 of the gamma ray detecting circuit 2, is input to a gamma ray absorption point calculating portion 42 and a gamma ray energy calculating portion 43. The gamma ray absorption point calculating portion 42 calculates the position of the absorption point Pa of the scattered gamma ray, and transmits the data to a gamma ray scattering direction vector calculating portion 44. The gamma ray energy calculating portion 43 calculates energy Eγ of the absorbed scattered gamma ray, and transmits the data to the gamma ray incident direction computing circuit 3. The gamma ray scattering direction vector calculating portion 44 calculates the scattering direction vector g of the scattered gamma ray based on the data on the Compton scattering point Pc from the recoil electron information calculating portion 27 and the data on the absorption point Pa of the scattered gamma ray, and transmits the data to the gamma ray incident direction computing circuit 3. The scattering direction vector g represents a unit vector in the scattering direction.

The gamma ray incident direction computing circuit 3 performs the following calculation based on the energy Ke of the recoil electron, the energy Eγ of the scattered gamma ray, the recoil direction vector e of the electron, and the scattering direction vector g of the gamma ray for each individual Compton scattering phenomenon. That is, Expressions (1), (2), and (3) are used to calculate an incident direction vector s (unit vector in the incident direction) of the incident gamma ray. Note that, in the expressions, m represents a rest mass of the electron and c represents the velocity of light. Further, α represents an angle formed by the recoil direction vector e of the electron and the scattering direction vector g of the gamma ray, and φ represents an angle formed by the incident direction vector of the incident gamma ray and the scattering direction vector g of the gamma ray.

$$\begin{matrix}s = ( cos φ - \frac{sin φ}{tan α} ) g + \frac{sin φ}{sin α} e & ( 1 ) \\ φ = {cos}^{- 1} ( 1 - \frac{{mc}^{2}}{{E}_{γ} + Ke} \cdot \frac{Ke}{{E}_{γ}} ) & ( 2 ) \\ α = {cos}^{- 1} \{ ( 1 - \frac{{mc}^{2}}{{E}_{γ}} ) \sqrt{\frac{Ke}{Ke + 2 {mc}^{2}}} \} & ( 3 )\end{matrix}$$

In addition, the image reconstruction device 4 converts the distribution of the radiation source into the image data based on the data on the Compton scattering point Pc and the incident direction vector s of each incident gamma ray, and the display device 5 displays the intensity distribution based on the image data by means of a tone or a color difference.

### Embodiment 2

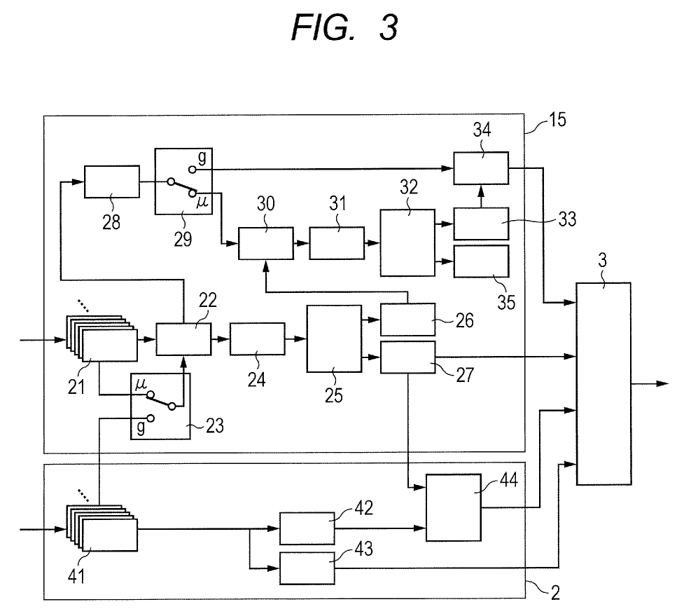

FIG. 3 illustrates configurations of the electron detecting circuit 15 and the gamma ray detecting circuit 2 according to this embodiment. In this embodiment, components and operations except for the alarm signal output portion 35 are the same as those of Embodiment 1, and hence descriptions thereof are omitted.

Also in this embodiment, the charged particle detecting device 1 includes the two operation modes of the gamma ray measuring mode and the calibration mode. In the calibration mode, in the same manner as in Embodiment 1, the coefficient A to be used for converting the energy Ke of the charged particle (recoil electron) based on the charge Qe is calculated. When the coefficient A falls within a set range, the coefficient A is saved in the memory portion 33. When the coefficient A falls out of the set range, it is determined that an abnormality has occurred, and the alarm signal output portion 35 outputs an alarm signal to a user. As the cause of the abnormality, change in the component of the gas 12, damage to the electron detector 14, or the like is conceivable. The user may determine the cause of the abnormality to take appropriate measures. To set the range, for example, the coefficient A is calculated when the device is used for the first time, and several percent (for example, 10%) around the calculated value is saved as the set range.

Note that, also in this embodiment, the ratio (sensitivity) of the energy Ke of the charged particle (recoil electron) to the detected charge Qe is saved in the memory portion 33 as the coefficient A, but another parameter for the sensitivity may be saved in the memory portion 33 as the coefficient.

### Other Embodiment

The object of the present invention may also be achieved by the following embodiment of a charged particle detecting method. That is, a storage medium having stored thereon a program code of software for implementing the functions (functions of the controller and the like) according to the above-mentioned embodiments is supplied to the charged particle detecting device, the gamma camera, or the like. The program code of software may also be supplied via a network. Then, a computer (or CPU, MPU, or the like) of the controller reads the program code stored on the storage medium, and executes the above-mentioned functions. In this case, the program code itself read from the storage medium implements the functions of the above-mentioned embodiments, and the program for detecting the charged particle and the storage medium having the program stored thereon constitute the present invention. Specifically, the charged particle detecting method according to this embodiment includes at least: detecting an ionized electron generated along a trajectory of a charged particle flying within a scatterer; processing the signal detected in the detecting to acquire information on the charged particle; selecting information on a muon from the information on the charged particle, which is acquired in the processing; accumulating the information on the muon; and acquiring a coefficient for sensitivity of detection of the information on the charged particle based on the accumulated information on the muon.

The charged particle detecting technology according to the present invention may be used for a gamma camera configured to perform environmental radiation measurement, nuclear medical diagnosis, or the like.

In the charged particle detecting device and the gamma camera according to the present invention, the calibration is performed by using the muon, which is a secondary cosmic ray existing in the natural world, to thereby acquire the coefficient for the sensitivity of the detection of the information on the charged particle (such as energy of the recoil electron). Accordingly, it is easy to automate the calibration, and as a result, it is possible to eliminate or reduce the need for complicated work to be performed by an operator.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-019810, filed Feb. 4, 2014 which is hereby incorporated by reference herein in its entirety.

### REFERENCE SIGNS LIST

1 . . . charged particle detecting device,

2 . . . gamma ray detecting circuit,

12 . . . gas (scatterer),

14 . . . electron detector (electron detecting portion),

15 . . . electron detecting circuit (signal processing portion),

16 . . . scattered gamma ray detector,

25 . . . selection portion,

30 . . . memory portion (accumulation portion),

32 . . . coefficient calculating portion (computing portion)

1. A radiation detecting device, comprising:
an electron detecting portion configured to detect an ionized electron generated along a trajectory of a charged particle flying within a scatterer;
a signal processing portion configured to process a signal detected by the electron detecting portion, to thereby acquire information on the charged particle;
a selection portion configured to select information on a muon from the information on the charged particle acquired by the signal processing portion;
an accumulation portion configured to accumulate the information on the muon; and
a computation portion configured to acquire a coefficient for sensitivity in detection of the information on the charged particle based on the accumulated information on the muon.

2. The radiation detecting device according to claim 1, wherein the electron detecting portion comprises:
a voltage applicating portion configured to form, in the scatterer, an electric field for drifting the ionized electron generated along the trajectory of the charged particle flying within the scatterer into a predetermined direction; and
a plurality of detectors configured to detect the ionized electron drifted by the electric field.

3. The radiation detecting device according to claim 1, further comprising an alarm signal output portion configured to output an alarm signal when the coefficient exceeds a predetermined range.

4. The radiation detecting device according to claim 1, wherein, of the information on the charged particle output by the electron detecting portion, energy of the charged particle is calculated by using the coefficient.

5. The radiation detecting device according to claim 1, wherein the selection portion selects the information on the muon based on positional information on the trajectory of the charged particle.

6. The radiation detecting device according to claim 1, wherein the computation portion determines the coefficient based on an energy loss of the muon and positional information on the trajectory in addition to the accumulated information on the muon.

7. The radiation detecting device according to claim 1, wherein the radiation detecting device executes separately a first operation mode for measuring the charged particle other than the muon and a second operation mode for selecting the information on the muon to accumulate the information.

8. The radiation detecting device according to claim 1, wherein a charged particle other than the muon comprises the charged particle based on an incident gamma ray.

9. A gamma camera comprising:
the radiation detecting device according to claim 8; and
a detector for detecting a scattered gamma ray generated by Compton scattering between an incident gamma ray and the scatterer.

10. The gamma camera according to claim 9, further comprising a unit configured to acquire an incident direction vector of the incident gamma ray based on energy of a recoil electron, energy of the scattered gamma ray, a recoil direction vector of the electron, and a scattering direction vector of a gamma ray for each individual Compton scattering phenomenon.

11. The gamma camera according to claim 9, further comprising an image reconstruction device configured to convert a distribution of a radiation source into image data based on data on a Compton scattering point and an incident direction vector of each incident gamma ray.

12. A radiation detecting method, comprising:
an electron detecting step of detecting an ionized electron generated along a trajectory of a charged particle flying within a scatterer;
a signal processing step of processing a signal detected in the electron detecting step, to thereby acquire information on the charged particle;
a selection step of selecting information on a muon from the information on the charged particle acquired in the signal processing step;
an accumulation step of accumulating the information on the muon; and
a computation step of acquiring a coefficient for sensitivity in detection of the information on the charged particle based on the accumulated information on the muon.

13. The radiation detecting method according to claim 12, further comprising calculating, of the information on the charged particle acquired in the signal processing step, energy of the charged particle by using the coefficient.

14. The radiation detecting method according to claim 12, wherein the selection step comprises selecting the information on the muon based on positional information on the trajectory of the charged particle.

15. The radiation detecting method according to claim 12, wherein the computation step comprises determining the coefficient based on an energy loss of the muon and positional information on the trajectory in addition to the accumulated information on the muon.

16. A program for causing a computer to execute the radiation detecting method of claim 12.
